(19) United States
(12) Patent Application Publication
(10) Pub. No.: US 2015/0258464 A1
(43) Pub. Date: Sep. 17, 2015

(54) Method and Apparatus for Molecular Targeting and Separation of Feedstock Fluids

(71) Applicant: Donald Ramer, Thornton, CO (US)

(72) Inventor: Donald Ramer, Thornton, CO (US)

(21) Appl. No.: 14/213,846

(22) Filed: Mar. 14, 2014

(51) Int. Cl. B01D 3/00; B01D 3/42; B01D 3/36; B01D 3/10

(52) U.S. Cl. CPC B01D 3/009; B01D 3/10; B01D 3/42; B01D 3/36

(57) ABSTRACT

Disclosed is an apparatus and method for separating constituent mixtures, whereby microwave energy is used to vaporize targeted constituents within the mixture at different rates based on specific parameters of the apparatus. The present apparatus and method can enable separation of numerous mixtures that are difficult to separate using conventional methods wherein the constituents have similar boiling points, azeotropes, alcohols, sulfides, amines, hydrocarbons, and other polar molecules or compounds. The disclosed technology can achieve repeated high purity yields of the final products while using less energy than conventional methods.

### CROSS-REFERENCE TO RELATED APPLICATION

This application is related to and claims the benefit of U.S. Provisional Patent Application App. No. U.S. 61/785,784 titled “Method and Apparatus for Molecular Targeting and Separation of Feedstock Fluids,” filed on Mar. 14, 2013, the complete subject matter of which is incorporated by reference herein in its entirety.

### STATEMENT REGARDING FEDERALLY SPONSORED RESEARCH AND DEVELOPMENT

Not Applicable

### BACKGROUND OF DISCLOSURE

1. Field of Invention

The present invention relates to an apparatus and method that utilizes microwave energy technology and a ‘tunable’ assembly of components and settings to separate and isolate one or more chemical constituents in a mixture, thus allowing for the recovery of high purity liquids from the separated mixture.

2. Description of Prior Art

The separation of mixtures into individual constituents is necessary for a number of industrial processes. For example, a number of solvents, such as mineral spirits, chlorinated solvents, alcohols, glycols, petroleum-based or synthetic waste oils, or paint-related waste, can become unsuitable for its original purpose due to accumulation of impurities or loss of original properties. What is needed is a separation system to promote the beneficial recycling and reuse of spent solvents and the proper handling and treatment of a broad spectrum of known or unknown mixtures. There exists a number of separation methods that attempt to meet industrial and environmental standards; however, these methods suffer from a number of disadvantages.

One of the most common methods used for separating fluid mixtures is conventional distillation, which generally involves the separation of mixtures based on differences in the boiling points of the constituents; however, these methods suffer from numerous disadvantages that the invention described herein overcomes. For conventional distillation methods, there is little or no ability for an operator to target the constituent of the mixture to enrich as product. In general, the constituent of the mixture that is enriched as product using conventional distillation methods is naturally predetermined to be the constituent having a lower boiling point; thus, conventional distillation is not a reasonable separation method to employ when it is desired to enrich the constituent of the mixture having a higher boiling point as distillate product.

Additionally, there exist a number of industrially significant azeotropic mixtures, which typically cannot be separated by conventional distillation methods without the inclusion of an additional constituent to help facilitate separation. However, the addition of an azeotrope presents unnecessary complexity to separation of the original mixture into its individual constituents because the azeotrope must then be separated from the mixture. There are a number of other types of constituent mixtures in which conventional distillation methods are not reasonable methods for separation. Examples include 1) mixtures of constituents in which the constituents have similar boiling points, and 2) mixtures of constituents in which at least one of the constituents, at elevated temperatures, degrades or irreversibly changes its own molecular structure or the molecular structure of another constituent in an undesirable manner.

Various devices that utilize microwave energy for the separation of liquids have been disclosed by others. U.S. Pat. No. 4,582,629 to Wolf and U.S. Pat. No. 4,810,375 to Hudgins and Wolf describe methods for using a combination of microwave energy and conventional heat to facilitate separation of oil and water emulsions. Similarly, U.S. Pat. No. 4,853,507 to Samardzija describes an apparatus for the de-emulsification of liquids in which microwave energy passes through a waveguide section into a volume wherein an emulsion flows and is separated into its constituents. These patents describe methods for separating two or more liquids that are generally immiscible and make no mention of separating mixtures of miscible liquids.

U.S. patent application U.S. Ser. No. 13/886,156 discloses distillation techniques wherein microwave energy is utilized to heat and vaporize the uppermost layer of a liquid mixture, and the resulting vapor is condensed and collected. This provides an alternative and possible improvement to conventional distillation; however, the method and apparatus disclosed does not enable an operator to target a desired constituent in the mixture to be separated and collected as a product.

The detailed description which follows will summarize the process of assembling and operating the molecular targeting and separation assembly and its associated devices and various observations made during the discovery thereof.

### SUMMARY OF THE DISCLOSURE

This invention resides in an apparatus and method for separating and purifying the individual constituents of mixtures, or feedstock, wherein at least one constituent in the mixture undergoes dielectric heating upon being irradiated with microwave energy. During operation of the apparatus, microwave energy is directed via a waveguide from a microwave energy source to a reactor assembly wherein a constituent mixture undergoes separation and emits vapors that undergo further separation as they ascend a column and are directed to a condenser assembly and a collection tank. Separation of a wide variety of mixtures into individual constituents having high purity levels is made possible by adjusting system parameters to provide the desired output. The disclosed apparatus enables an operator to target the desired constituents in a mixture to be purified and collected as product.

The disclosed separation method herein can be applied to a number of reaction mixtures and reactor types, such as batch reactors, continuously stirred tank reactors, or plug flow reactors, to enhance the yields and purity of reaction products. The apparatus can operate under vacuum, at ambient pressure, or at greater than ambient pressure. For many mixtures, separation may be further enhanced and made safer to the operator by way of one or more embodiments described herein.

In an embodiment, the apparatus is equipped with a microwave choke located between the column and condenser assembly for enhancing separation for numerous mixtures.

In an embodiment, the reactor assembly is equipped with a heat exchanger to increase versatility in the ability to select constituents to separate and to increase the purity of the product resulting from the process.

In an embodiment, the reactor assembly is equipped with a fluid circulation assembly that circulates the mixture in a controlled manner to allow for greater versatility in the ability to select constituents to separate and to increase the purity of the product resulting from the process.

In an embodiment, the reactor assembly or its contents further comprise a supplemental microwave absorbing material, suspended or dissolved, that increases in temperature upon being irradiated with microwave energy. This material has been contemplated to enhance the ability for the disclosed apparatus to separate some types of mixtures, and also facilitates separation of constituent mixtures not containing a constituent that undergoes dielectric heating upon being irradiated with microwave energy.

In an embodiment, the waveguide window has been modified, or treated, to improve overall performance of the apparatus and to address safety issues when operating the device for some types of mixtures.

In an embodiment, the apparatus is further equipped with a grounding gasket to address safety issues when operating the device for some types of mixtures.

The term “constituent” is used herein to denote a material, chemical compound or substance.

The term “component” is used herein to denote a part, or piece, of apparatus.

The term “feedstock” is used herein to denote a mixture of constituents that is inserted into the reactor assembly prior to or during the course of operation. Feedstock may be known or unknown in composition, liquid or vapor, and may further comprise a solid, dissolved or suspended.

The term “operator” is used herein to denote a person that operates the apparatus.

The term “product” is used herein to denote the material separated from the constituent mixture that has passed through the column and condenser sections of the apparatus, and is collected.

The term “vapor” is used herein to denote a constituent or group of constituents in a gaseous or vapor phase after the constituent mixture has been exposed to a microwave energy source.

### BRIEF DESCRIPTION OF THE DRAWINGS

FIG. 1 is a side view of the molecular targeting and separation apparatus, in accordance with a first exemplary embodiment of the present invention.

FIG. 2 is a side view of the molecular targeting and separation apparatus further equipped with a heat exchanger, in accordance with an exemplary embodiment of the present invention.

FIG. 3 is a side view of the molecular targeting and separation apparatus further equipped with a fluid circulation assembly, in accordance with an exemplary embodiment of the present invention.

FIG. 4 is a side view of the molecular targeting and separation apparatus further equipped with a heat exchanger, a fluid circulation assembly, and an electrical grounding gasket, in accordance with an exemplary embodiment of the present invention.

FIG. 5 is a process flowchart of the method described herein.

Before explaining the disclosed embodiments of the disclosed device in detail, it is to be understood that the device is not limited in its application to the details of the particular arrangements shown, since the device is capable of other embodiments. Also, the terminology used herein is for the purpose of description and not of limitation.

### DETAILED DESCRIPTION OF THE DISCLOSED EMBODIMENTS

The following description is provided to enable any person skilled in the art to make and use the disclosed apparatus and method. Various modifications, however, will remain readily apparent to those skilled in the art, since the generic principles of the present apparatus and method have been defined herein specifically to provide for an apparatus and method for separating a wide variety of mixtures into individual constituents, by exposing the constituent mixture to microwave energy and adjusting various parameters of the apparatus until the desired product is obtained.

It is generally established that microwave energy is well-suited for affecting polar molecules (e.g., alcohols, water and glycols). In general terms, polar molecules have a partial positive charge at one end and a partial negative charge at another end, and the molecules rotate as they align themselves with the alternating electric field of the microwave energy. Generally, material that is more polar will be affected more than a material that is less polar or nonpolar. Thus, microwave energy has varying effects on the constituents in a mixture to different extents based on their polarity or lack thereof.

Microwave energy in the present disclosure is used to subject the constituents in a fluid mixture to rapid rotational activation which, when complimented with proper adjustment of system parameters, causes the constituents to separate from each other until the process results in a product highly enriched with the desired material. For a wide variety of mixtures, the disclosed device presents numerous benefits, higher product purity, lower energy consumption, as well as acceleration of reaction rates, and higher reaction yields for reactive mixtures. Additionally, the disclosed device enables an operator to select which constituent to enrich and collect as product, in spite of the respective boiling points of each constituent.

Whilst it may be economically and environmentally advantageous to use the apparatus and method described herein for large or industrial scale applications, such as the prevention, treatment or processing of industrial wastes, it is contemplated that this device will also achieve similar results for small or lab scale applications.

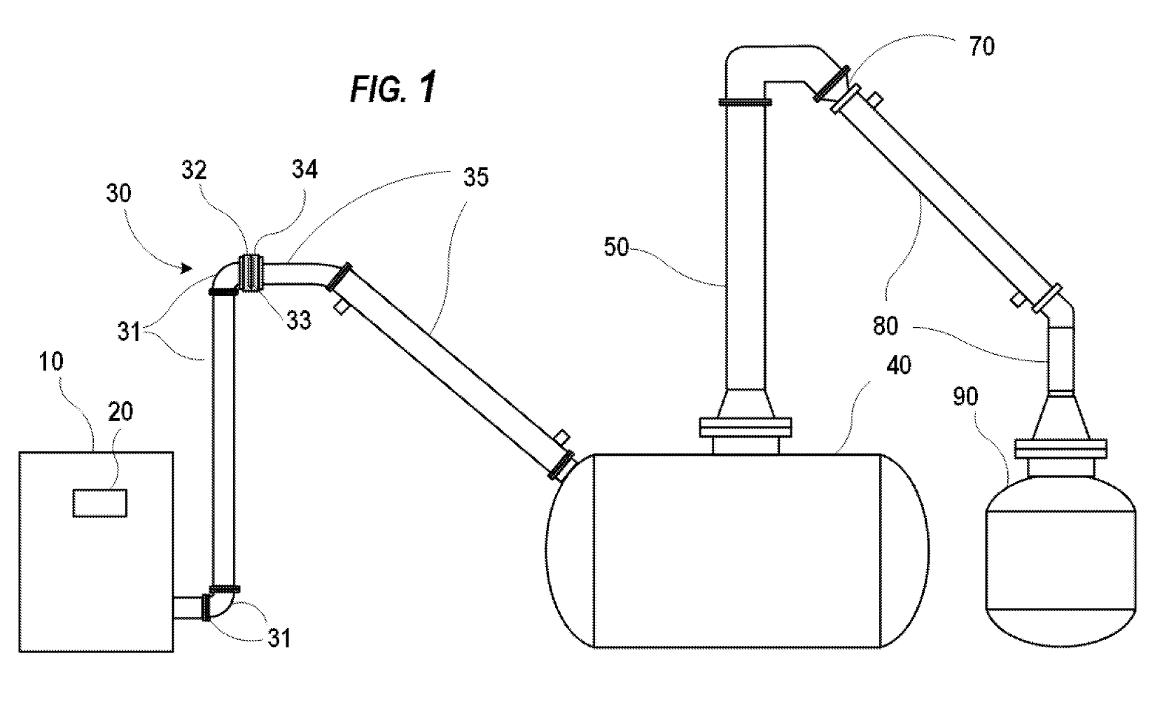

FIG. 1 is a side view of the molecular targeting and separation apparatus, in accordance with a first exemplary embodiment of the present invention. The apparatus comprises a microwave energy source 10, a programmable logic controller (PLC) 20, a waveguide 30, a reactor assembly 40, a column 50, a microwave choke 70, a condenser assembly 80, and a collection tank 90. During operation of the described apparatus, a constituent mixture 160 is inserted into the reactor assembly 40.

The microwave energy source 10 is designed to be capable of producing electromagnetic energy at frequencies generally within or near the range of 300 megahertz and 300 gigahertz. The PLC 20 is an optionally equipped electronic device which improves the ability for an operator to in addition to other parameters and variables, to adjust the power output of the microwave energy source 10, which can be varied as desired. The electromagnetic frequencies that the microwave energy source 10 produces cannot be adjusted for many microwave energy sources currently available commercially, as they are typically preset upon construction; however, it is contemplated that equipping the described apparatus with a variable frequency transmitter would be advantageous.

The waveguide 30 is designed to conduct and direct microwave energy from the microwave energy source 10 to the reactor assembly 40 and also to restrict the flow of the constituent mixture 160 to the microwave energy source 10, thus enhancing separation for many cases and reducing safety risks that an operator may encounter while operating the apparatus. The waveguide 30 comprises a waveguide section 31, flanges 32 and 34, a waveguide window 33, and a cooled waveguide section 35. The waveguide section 31 generally extends outward from a side wall of the microwave energy source 10 and is connected to the waveguide window 33 at the other end portion via flange 32. The waveguide window 33 is generally secured at the apex between waveguide section 31 and cooled waveguide section 35 via flange 32 and flange 34 respectively. It is contemplated that the waveguide window 33 be formed from a material exhibiting high strength and transparency to microwave energy at both lowered and elevated temperatures, although other types of materials may be suitable. The waveguide section 31 and cooled waveguide section 35 are typically hollow and exhibit either a rectangular cross-sectional shape or an elliptical cross-sectional shape. A bottom surface of waveguide section 31 may comprise a plurality of slots to allow air flow there through. The waveguide section 31 and cooled waveguide section 35 are generally designed and configured to facilitate the protection of the waveguide window 33 and to direct microwave energy to the reactor assembly 40 in a manner that enhances operation of the described apparatus. It is often desirable that at least one of either waveguide section 31 or cooled waveguide section 35 have at least one bend, or angle change between 0 and 180 degrees, to assist in directing microwave energy into the reactor assembly 40. The cooled waveguide section 35 generally incorporates water-cooling to cool vapors and liquids traversing towards the waveguide window 33 from the reactor assembly 40, thus increasing the long term duration of waveguide window 33 and the overall safety of operating the described apparatus.

The reactor assembly 40 is designed to store the constituent mixture 160 for processing and is in fluid communication with the column 50 at or near the top end portion of reactor assembly 40. The reactor assembly may comprise a batch reactor, a continuously stirred tank reactor, a plug flow reactor, or a variety of other reactor types. The column 50 generally extends upward from reactor assembly 40, where it receives ascending vapors and microwave energy during operation. The top end portion of the column 50, which may exhibit bends, or angle changes, to redirect flow of vapors in a desired direction, is in fluid communication with the condenser assembly 80, which designed to cool vapors traversing within the condenser assembly 80; in many cases, cooling of the vapors results in condensation of at least one of the constituents in the vapor. The height, diameter, and bends of the column 50 can be adjusted, as desired, by replacement of the column 50 whilst the described apparatus is not in operation.

In an embodiment and as shown in FIG. 1, the described apparatus may be equipped with a microwave choke 70 between and in fluid communication with the column 50 and condenser assembly 80. The microwave choke 70, generally takes the form of a reducer and exhibits a larger diameter end portion that connects with the top end portion of column 50 and a smaller diameter end portion that connects to the condenser assembly 80. Whilst the inventor does not intend to be bound to any particular theory, it is believed that the microwave choke 70 forms a venturi, or a partial vortex which further enhances separation of vapors traversing from the column 50 to the condenser assembly 80. Additionally, the microwave choke 70 limits, or restricts, microwave energy from entering the condenser assembly 80 or the collection tank 90.

The condenser assembly 80 is in fluid communication with the collection tank 90, and exhibits a cooling rate that can be varied as desired and receives cooled vapors or liquid and is sized to meet the desired output for the separation process. The collection tank 90 may be equipped to and in fluid communication with an external storage tank and a fluid pump capable of transferring product to the external storage tank.

Although the cooled waveguide section 35 and the condenser assembly 80 may generally be any type of heat exchanger that removes heat from the constituents traversing within, it is often economically desirable that each of these components take the general form of a shell and tube type heat exchanger, or condenser, wherein a cooling fluid passes through the space between the outer walls of the tube and the exterior shell to cool hot fluids traversing within the tube. Whilst it is generally desirable that the condenser assembly 80 utilize an inexpensive and effective cooling fluid such as water, it is contemplated that other cooling fluids, such as air or a water and glycol mixture, are suitable.

In one embodiment, the waveguide 30 comprises a waveguide window 33 that is generally mounted in a custom-sized window frame via flanges 32 and 34. As modified, the waveguide window 33 has a reduced dielectric loss, does not fog, and allows for the system to hold a vacuum over a broader temperature range. For example, it was observed that the dielectric loss of the window had improved after treatment to be less than 0.1%. It was also observed that the thickness of the window can be varied to allow for the increase in vacuum and the separation of a more contaminated feedstock fluid stream.

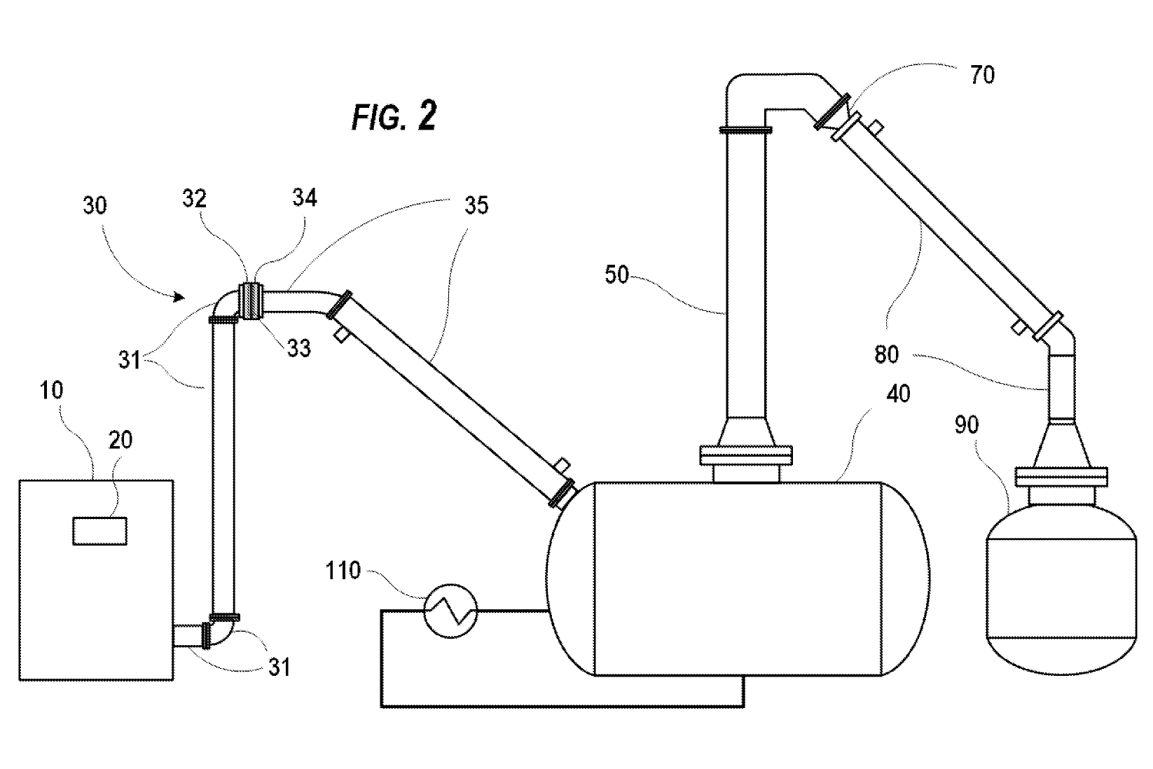

FIG. 2 is a side view of the molecular targeting and separation apparatus further equipped with a heat exchanger, in accordance with an exemplary embodiment of the present invention. The heat exchanger 110 is in thermal communication with the reactor assembly 40 and assists in the acceleration of the targeting and separation process for many mixtures by transferring thermal energy to or from the constituent mixture 160 contained within the reactor assembly 40. It is contemplated that many types of heat exchangers may be suitable for enhancing separation of many mixtures. Examples of heat exchangers include, but are not limited to, double pipe heat exchangers, shell and tube heat exchangers, plate heat exchanger, and plate and shell heat exchangers. Additionally, the heat exchanger may comprise a simple thermal bath into which the reactor assembly 40 is submerged.

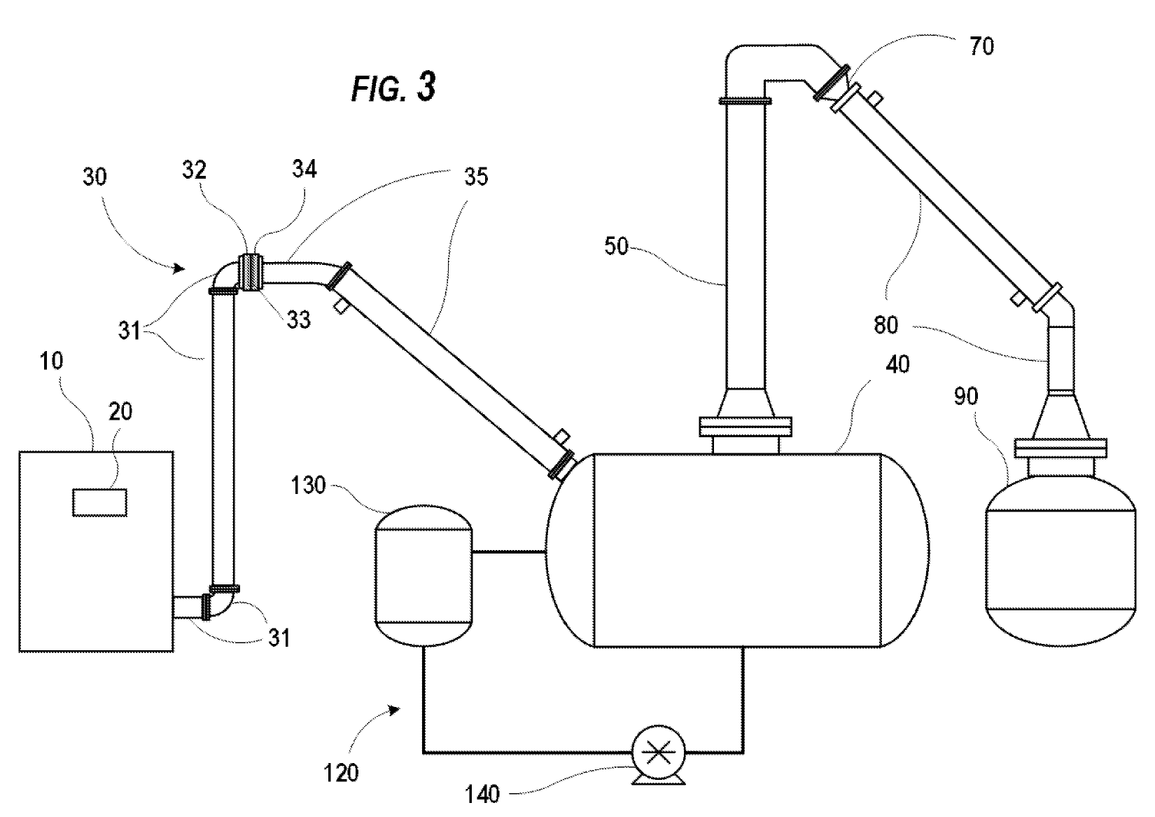

FIG. 3 is a side view of the molecular targeting and separation apparatus further equipped with a fluid circulation assembly, in accordance with an exemplary embodiment of the present invention. The fluid circulation assembly 120 is designed to circulate the constituent mixture 160, continuously or intermittently, to and from the reactor assembly 40, further enhancing the separation of many mixtures. There exist numerous arrangements of the fluid circulation assembly 120 that are suitable for enhancing separations using the described apparatus. By way of example, the fluid circulation assembly 120 in FIG. 3 comprises a surge tank 130 and a fluid pump 140 in fluid communication with each other and with the reactor assembly 40. The fluid pump 140 induces traversing of the constituent mixture 160 to, from, and within the reactor assembly 40 and the fluid circulation assembly 120, and the surge tank 130 collects and temporarily stores a desired volume of the constituent mixture 160 being circulated within the fluid circulation assembly 120 for a desired amount of time. Additionally, the fluid circulation assembly may comprise valves to enhance control of the circulation provided by fluid pumps.

In an embodiment, the apparatus is further equipped with a grounding gasket 150 that is designed to provide an electrical ground for the apparatus. This reduces arcing that may occur, and thus reduces safety risks for cases when the constituent mixture 160 emits vapors that are flammable. The grounding gasket 150 is made from an electrically conductive material, such as copper, and is generally secured between the reactor assembly 40 and the column 50, however it is contemplated that equipping the grounding gasket 150 at other locations of the apparatus would be suitable.

In one embodiment, a supplemental microwave absorbing material has been added to the constituent mixture 160, either by dissolution of the supplemental microwave absorbing material into or by suspension in the constituent mixture 160. The supplemental microwave absorbing material is in thermal communication with the constituent mixture 160, is designed to undergo dielectric heating upon being irradiated with microwave energy, and can be used in substitution for or in complementary unison with a heat exchanger 110 to provide thermal energy to the constituent mixture 160, which enhances separation for some cases, including cases where it has been discovered that elevating the temperature of the constituent mixture 160 results in the desired product being obtained. The material may take a number of forms or shapes, which may include but are not limited to, cylindrical rod, powder, disk, etc. Examples of supplemental microwave absorbing materials which are suitable for this embodiment include, but are not limited to, silicon carbide, inorganic salts, and many organic materials.

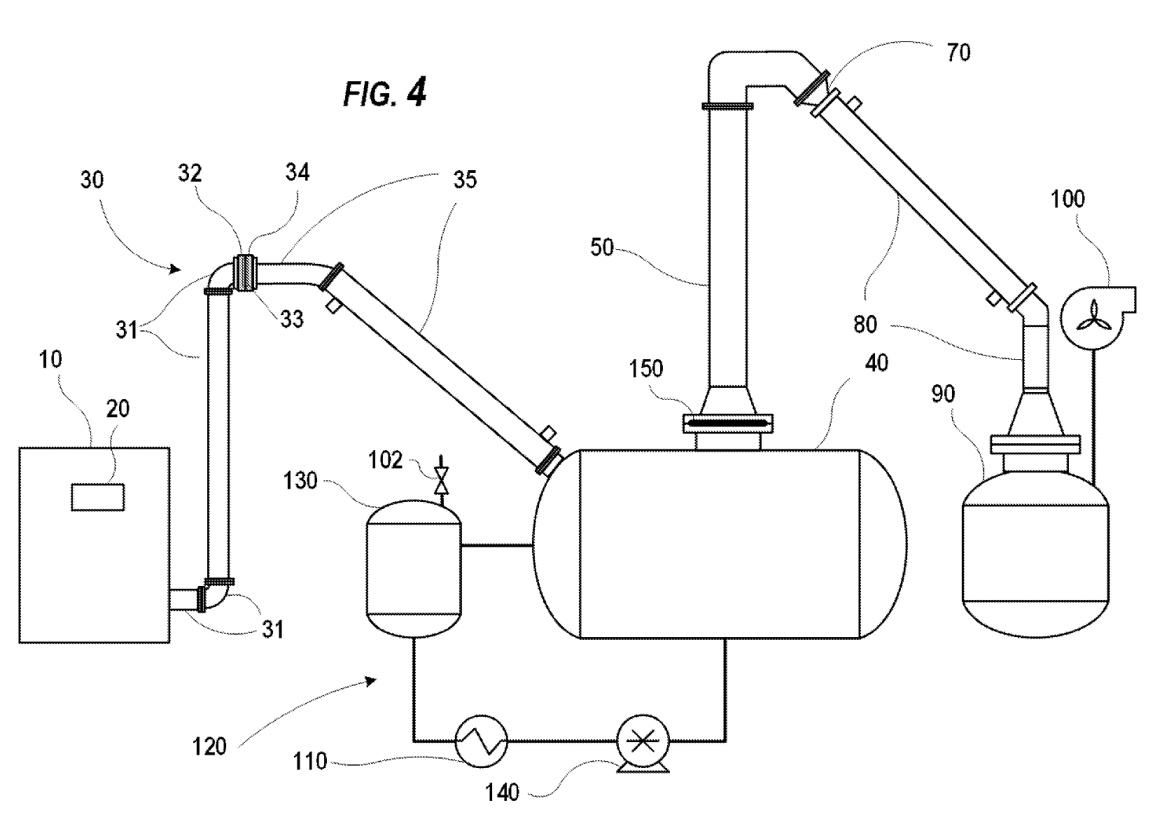

FIG. 4 is a side view of the molecular targeting and separation apparatus equipped with a heat exchanger, a fluid circulation assembly, a valve, a vacuum pump, and a grounding gasket, in accordance with an exemplary embodiment of the present invention. In many cases, it is desirable that the apparatus be equipped with components from various embodiments described herein. By way of example, the fluid circulation assembly 120 in FIG. 4 comprises a surge tank 130 and a fluid pump 140 and is equipped to the reactor assembly 40 along with heat exchanger 110 and grounding gasket 150. It should be recognized that this embodiment further enhances control of thermal energy transfer to and from the constituent mixture 160, thus further reducing safety risks that may be encountered during operation. Although it is not a necessary component of the apparatus, a valve 102 may be equipped to the reactor assembly 40, or other components of the apparatus as desired, to assist in insertion of the constituent mixture 160 or an external atmosphere of choice into the reactor assembly 40. In FIG. 4, the valve 102 is located, by way of example, on the surge tank 130, which may be a desirable location for enhancing separation for many mixtures. Additionally, vacuum can be applied to the system by way of a vacuum pump 100 for further enhancing separation in many cases. It is also known to those skilled in the art that there be multiple configurations of apparatus components that would produce similar results. For example, a plurality of at least one of the various apparatus components is contemplated to enhance separation in many cases.

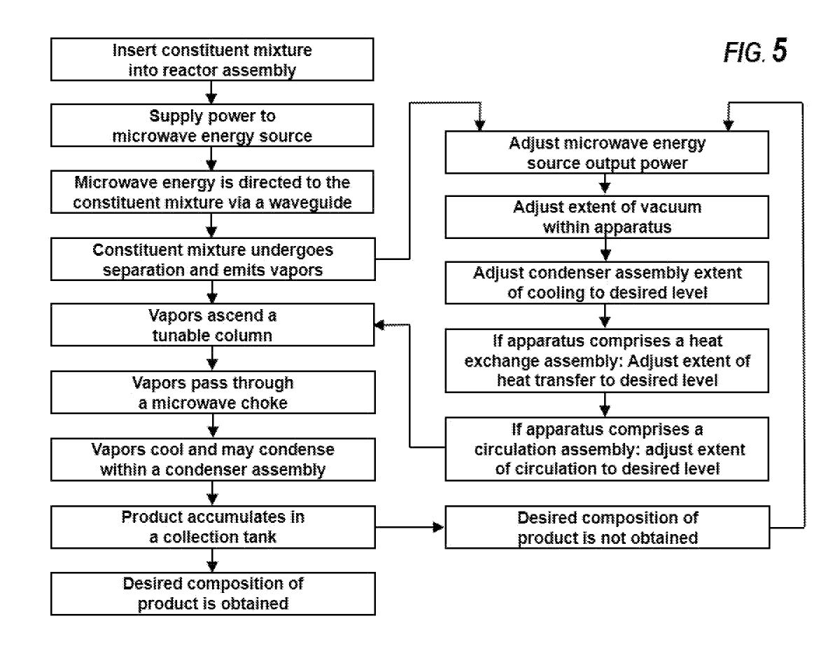

A method for separating the constituents of constituent mixtures 160 using the aforementioned apparatus will now be described. FIG. 5 is a process flowchart of the method described herein. The apparatus is capable of separating constituent mixtures wherein the molecular structure of at least one constituent in the constituent mixture 160 comprises a functional group that absorbs microwave energy. Additionally, as described in an embodiment, the inclusion of a supplemental microwave absorbing material to the constituent mixture 160 enhances separation of constituent mixtures, including constituent mixtures wherein none of the original constituents comprise a functional group that absorbs microwave energy. Examples of functional groups that absorb microwave energy include, but are not limited to, (—OH, —NH₂, —SH, etc.). Thus, examples of constituents that may be separated using the described apparatus without the addition of a supplemental microwave absorbing material include, but are not limited to, water, glycols, glycerol, amines, etc.

The apparatus is designed to process and separate fluidic mixtures, which may be of known or unknown composition, and may be vapor phase, liquid phase, or a combination of liquid and vapor phases, and may additionally comprise solids, either dissolved or suspended.

The operation of the described apparatus generally begins with the constituent mixture 160 being inserted into the reactor assembly 40, which may be performed manually by an operator, or by way of a valve 102 in the alternative, which may be equipped to the apparatus at a desired location. Power to the microwave energy source 10 is turned on and set to a desired level. It is submitted that a programmable logic controller or PLC 20 controlling the settings of the process to be carefully monitored and regulated by the operator so that the reactions may progress properly and the desired product may be obtained. The waveguide 30 safely directs microwave energy from the microwave energy source 10 to the reactor assembly 40, wherein the microwave energy is absorbed by at least one constituent of the constituent mixture 160 or by a supplemental microwave absorbing material, as described in an embodiment. This causes the composition of the constituent mixture 160 to change as vapors are emitted and ascend the column 50, passes through the microwave choke 70, cools and, in many cases, condenses in the condenser assembly 80, and is collected in the collection tank 90. The disclosed method results in a product having a composition of constituents that differs, often significantly, from the composition of the constituent mixture 160 originally contained in the reactor assembly 40. The product in the collection tank 90 can then be stored within the collection tank or transferred to and stored within tanks external to the apparatus. A vacuum pump 100 facilitates the operation of the described apparatus at reduced pressures, which may be advantageous in many cases. During operation, an operator may adjust various parameters until the desired product is obtained. Parameters include power output to the microwave energy source 10, the extent of cooling taking place in the condenser assembly 80, the extent of vacuum applied by the vacuum pump 100 when applicable, the extent of heat transfer applied by the heat exchanger 110 and the extent of circulation applied by fluid circulation assembly 120 when applicable. The disclosed method enables the disclosed apparatus to separate numerous constituent mixtures, including azeotropes. For constituent mixtures comprising constituents with various boiling points, the disclosed method can be used to enrich the higher boiling point liquid or the lower boiling point liquid in the product, as desired by the operator.

It is contemplated by the inventor that an accelerating constituent may be added to the constituent mixture in order to increase reaction rates for a constituent mixture undergoing reaction in the described apparatus.

It should be recognized that modifications of the apparatus and methods disclosed herein to make the technology suitable for treating and purifying solids and gases would fall within the scope of the disclosure. Implementation of such devices and methods will necessarily be determined through engineering and technically sound design decisions to meet the goal(s) to be achieved.

This disclosed device provides for a method and apparatus for separating the constituents in fluid streams into individual constituents exhibiting high purity. The disclosed device is capable of processing a broad spectrum of mixtures. In addition, the process is repeatable. It is recognized that various types of feedstock may require ventilation. In such cases, the disclosed device can be modified with an appropriate control device such as a scrubber.

The disclosed device can be sited as a permanent, semi-permanent or mobile configuration. For example, it has been contemplated that such a unit may be placed on a flatbed trailer or railcar to accommodate processing at remote locations or in transient situations. Because it can be integrated into an existing system, the disclosed device is not limited to being a standalone device. For example, it can be as a post-treatment system in a biofuel plant, if desired. It should be recognized that modifications of the apparatus and methods disclosed herein making the technology suitable for treating and purifying numerous constituent mixtures once an initial baseline analysis has been established.

Although the disclosed device and method have been described with reference to disclosed embodiments, numerous modifications and variations can be made and still the result will come within the scope of the disclosure. No limitation with respect to the specific embodiments disclosed herein is intended or should be inferred.

I claim:

1. An apparatus for molecular targeting and separating mixtures, said apparatus comprising:
a constituent mixture comprising separable constituents;
a microwave energy source capable of transmitting microwave energy;
a reactor assembly, whereby said constituent mixture is stored and undergoes separation to emit vapors;
a waveguide wherein microwave energy is conducted and directed from said microwave energy source to said reactor assembly;
a column in fluid communication with said reactor assembly whereby said microwave energy and said vapors are conducted there through;
a condenser assembly whereby said vapors are cooled; and
a collection tank whereby cooled or condensed said vapors are collected.

2. The apparatus of claim 1, wherein said waveguide comprises a waveguide section; a cooled waveguide section; a waveguide window; and one or more flanges to secure said waveguide window between said waveguide section and said cooled waveguide section.

3. The apparatus of claim 1, wherein said reactor assembly further comprises a supplemental microwave absorbing material coated around the reactor assembly.

4. The apparatus of claim 1, wherein said constituent mixture further comprises a supplemental microwave absorbing material.

5. The apparatus of claim 1, wherein said waveguide further comprises a rectangular cross section form.

6. The apparatus of claim 1, wherein said waveguide further comprises an elliptical cross section form.

7. The apparatus of claim 1, wherein said apparatus further comprises a microwave choke.

8. The apparatus of claim 1, wherein said column is constructed to provide angle changes from at or between 0 and 90 degrees between said column and said condenser assembly.

9. The apparatus of claim 1, wherein the microwave energy transmitted by the microwave energy source is within an approximate frequency range of at or between 300 megahertz and 300 gigahertz.

10. The apparatus of claim 1, wherein said condenser assembly comprises a double tube heat exchanger.

11. The apparatus of claim 1, wherein said condenser assembly comprises a shell and tube heat exchanger.

12. The apparatus of claim 1, wherein said condenser assembly utilizes water as a cooling fluid.

13. The apparatus of claim 1, wherein said condenser assembly utilizes a mixture of water and glycol as a cooling fluid.

14. The apparatus of claim 1, wherein said collection tank is equipped externally to and in fluid communication with an external storage tank and a fluid pump capable of transferring product to said storage tank.

15. The apparatus of claim 1, wherein said reactor assembly is equipped with a valve.

16. The apparatus of claim 1, further comprising a programmable logic controller.

17. The apparatus of claim 1, wherein said reactor assembly comprises a batch reactor.

18. The apparatus of claim 1, wherein said reactor assembly comprises a continuously stirred tank reactor.

19. The apparatus of claim 1, wherein said reactor assembly comprises a plug flow reactor.

20. The apparatus of claim 1, wherein said reactor assembly further comprises a heat exchanger.

21. The apparatus of claim 20, wherein said heat exchanger comprises a double tube heat exchanger.

22. The apparatus of claim 20, wherein said heat exchanger comprises a hollow coil submerged in a thermal bath wherein a fluid is circulated through the coil.

23. The apparatus of claim 20, wherein said heat exchanger comprises a tank comprising a cooling fluid in which said reactor assembly is submerged.

24. The apparatus of claim 20, wherein said heat exchanger comprises one or more shell and tube heat exchangers.

25. The apparatus of claim 1, further comprising a fluid circulating assembly.

26. The apparatus of claim 25, wherein said reactor assembly comprises a valve for assisting the insertion of said constituent mixture or an external atmosphere into said reactor assembly.

27. The apparatus of claim 25, wherein said fluid circulating assembly comprises a fluid pump in fluid communication with said reactor assembly.

28. The apparatus of claim 27, wherein said fluid circulating assembly further comprises a coil in fluid communication with said fluid pump and said reactor assembly.

29. The apparatus of claim 27, wherein said fluid circulating assembly further comprises a surge tank in fluid communication with said fluid pump and said reactor assembly.

30. The apparatus of claim 1, further comprising a grounding gasket in electrical communication with electrical ground.

31. The apparatus of claim 30 wherein said grounding gasket is constructed from a copper alloy.

32. The apparatus of claim 2, wherein said waveguide window is constructed from a material substantially transparent to microwave energy.

33. The apparatus of claim 2, wherein said waveguide window is constructed from a material comprising poly-(tetrafluoroethylene).

34. The apparatus of claim 2, wherein said waveguide section comprises one or more bends from at or between 0 and 90 degrees between said microwave energy source and said waveguide window.

35. The apparatus of claim 2, wherein said cooled waveguide section comprises one or more bends from at or between 0 and 90 degrees between said microwave energy source and said waveguide window.

36. The apparatus of claim 2, wherein said cooled waveguide section further comprises a shell and tube heat exchanger.

37. The apparatus of claim 2, wherein said cooled waveguide section further comprises water as a cooling fluid.

38. The apparatus of claim 2, wherein said cooled waveguide section further comprises a mixture of a glycol and water as a cooling fluid.

39. A method for separating mixtures using a molecular targeting and separation apparatus, said method comprising the steps of:
inserting a constituent mixture comprising a separable constituents into a reactor assembly;
directing microwave energy via a waveguide from a microwave energy source wherein said reactor assembly and said microwave energy causes said constituent mixture to emit vapors that ascend a column;
cooling said vapors within a condenser assembly to produce a product; and
collecting said product in a collection tank.

40. The method of claim 39, further comprising the step of adjusting the height of said column.

41. The method of claim 39, further comprising the step of adjusting the diameter of said column.

42. The method of claim 39, further comprising the step of adjusting one or more bends of said column.

43. The method of claim 39, further comprising the step of adjusting the extent of cooling of said condenser assembly.

44. The method of claim 39, further comprising the step of directing the vapors through a microwave choke.

45. The method of claim 39, further comprising the step of adjusting the diameter of the microwave choke.

46. The method of claim 39, further comprising the step of transferring said product from said collection tank to an external tank.

47. The method of claim 39, further comprising the step of applying vacuum to said reactor assembly.

48. The method of claim 39, further comprising the step of adding an accelerating constituent to the constituent mixture.

49. The method of claim 48, wherein said accelerating constituent comprises silicon carbide.

50. The method of claim 39, further comprising the step of suspending a supplemental microwave absorbing material in said constituent mixture.

51. The method of claim 39, further comprising the step of providing electrical ground via a grounding gasket to said apparatus.

52. The method of claim 39, further comprising the step of adjusting microwave energy output power toward the mixture via a programmable logic controller.

53. The method of claim 39, further comprising the step of adjusting output frequency of said microwave energy source to affect penetration of said microwave energy into said constituent mixture.

54. The method of claim 39, further comprising the step of transferring thermal energy to or from said constituent mixture via a heat exchanger.

55. The method of claim 39, further comprising the step of directing microwave energy at an approximate frequency range of at or between 300 megahertz and 300 gigahertz.

56. The method of claim 39, further comprising the step of circulating said constituent mixture to and from said reactor assembly via a fluid circulation assembly.

57. The method of claim 56, further comprising the step of adjusting circulation provided by said fluid circulation assembly.

58. The method of claim 56, further comprising the step of circulating said constituent mixture within said fluid circulation assembly via a fluid pump.

59. The method of claim 39, wherein said constituent mixture comprises a lower boiling point liquid and a higher boiling point liquid.

60. The method of claim 59, wherein said product is more enriched with said lower boiling point liquid relative to said constituent mixture.

61. The method of claim 59, wherein said product is more enriched with said higher boiling point liquid relative to said constituent mixture.

62. The method of claim 39, wherein said constituent mixture comprises an azeotropic mixture.

63. A system for molecular targeting and separation of mixtures, said system comprising:
a constituent mixture comprising separable constituents;
a microwave energy source capable of transmitting microwave energy to a reactor assembly, said reactor assembly configured to receive said constituent mixture;
a waveguide capable of directing said microwave energy to said reactor assembly;
a column in fluid communication with said reactor assembly;
a condenser assembly in fluid communication with said column; and
a collection tank.

64. The system of claim 63, wherein said waveguide comprises a waveguide section; a cooled waveguide section; a waveguide window; and one or more flanges to secure said waveguide window between said waveguide section and said cooled waveguide section.

65. The system of claim 63, further comprising a microwave choke.

66. The system of claim 63, further comprising a vacuum pump.

67. The system of claim 63, further comprising a grounding gasket.

68. The system of claim 63, further comprising a programmable logic controller.

69. The system of claim 63, further comprising a heat exchanger.

70. The system of claim 63, further comprising a fluid circulation assembly.
